(19) United States
(12) Patent Application Publication
(10) Pub. No.: US 2013/0283145 A1
(43) Pub. Date: Oct. 24, 2013

(54) Approximating Electronic Document Last Reading Position

(71) Applicant: INTERNATIONAL BUSINESS MACHINES CORPORATION, Armonk, NY (US)

(72) Inventor: Daniel J. Argent, Essex (GB)

(21) Appl. No.: 13/859,943

(22) Filed: Apr. 10, 2013

(30) Foreign Application Priority Data
Apr. 19, 2012 (GB) 1206881.3

(51) Int. Cl. G06F 17/24

(52) U.S. Cl. CPC G06F 17/241
USPC 715/231

(57) ABSTRACT

Disclosed is a method for approximating the final reading position in an electronic document such as an e-book. The final reading position is approximated by first establishing a reading speed of the reader of the e-book, which reading speed is used to approximate the final reading position on the most recently displayed page of the e-book, for instance by measuring how long the page has been displayed for and using the reading speed and this time period to obtain an approximate final reading position on the most recently displayed page. A computer program product containing this method and a system for executing this method are also disclosed.

### FIELD OF THE INVENTION

The present invention relates to a method for approximating the last reading position in an electronic document such as an e-book.

The present invention also relates to a method for displaying such a document on a computer.

The present invention further relates to a computer program product comprising computer-readable program code for implementing at least one of these methods.

The present invention yet further relates to a system including this computer program product.

### BACKGROUND

The electronic reading of documents, that is, reading documents from a display screen of an electronic device such as an e-book reader, tablet, smart phone, laptop or desktop computer and so on, has become increasingly commonplace over the last few years. In particular, the portability of some of these electronic devices has caused a surge in electronic reading ‘on the move’, e.g. during commuter journeys using public transport, holiday travel and so on.

In fact, many people now own several electronic devices that are suitable for e-reading, e.g. a smart phone, a dedicated e-reader, a laptop and so on, and such people may want to transfer an electronic document currently being read between suitably programmed electronic devices. For instance, a person may want to use a smart phone whilst on the move but an e-book reader or desktop computer whilst at home or work to read the document.

However, the portability of the electronic document between such devices is not without problems. In particular, in order to give the user the best possible reading experience, it is desirable that the electronic device to which the electronic document is transferred displays the text in the document where the user previously stopped reading, i.e. displays the last reading position, such that the user does not have to scroll through the electronic document to find this position, which can be annoying.

Several solutions exist that try to meet this requirement. For instance, the Google Reader™ tags the (top of the) last viewed page of an electronic document. Amazon Kindle™ uses a solution called Whispersync™, which automatically synchronizes bookmarks and a reading location among devices registered to the same Amazon.com account. When opening a Kindle™ book or archived personal document on another device, the user is given the choice to go to the furthest page read if the user is further ahead on the other device.

However, when porting an electronic document between electronic devices having different screen sizes, the view of the electronic document may have to be adjusted or altered to fit the screen of the destination device, e.g. by repagination, font size changes and the like.

This is schematically depicted in FIG. 1. A person (user) reading an electronic document on a first electronic device 10 may have finished reading at the words ‘cliff hanger’ highlighted in bold on the screen of the first electronic device 10, such that this word has become the last reading position in this document. The electronic document may be tagged with the end point of the page displayed by the first electronic device 10 to allow the most recent view of the electronic document to be restored upon reopening the document. This of course works well when the document is reopened on the first electronic device 10, as exactly the same page will be displayed, which therefore contains the last reading position.

However, if the electronic document is loaded onto the second electronic device 20 which has a different (here smaller) screen size than the first electronic device 10, as indicated by the arrow in FIG. 1, the second electronic device 20 will display only a portion of the last page as displayed on the first electronic device 10, which portion may not contain the actual last reading position, which has the undesirable consequence that the user will have to scroll through the document to manually find this position therein.

U.S. Pat. No. 7,870,272 B2 discloses a content management system, which stores location information indicating a location within a content item where a user exited from or last-accessed the content item. This location information is synchronized or otherwise shared between or among a plurality of devices associated with the user. With this information stored on or accessible to these multiple devices, the system enables the user to start from that location when subsequently accessing the content item on any of these devices.

For static content such as an e-book, the last page is stored as the location information. Consequently, this solution also fails to solve the aforementioned problem caused by the change in a layout of the electronic document between devices. Moreover, this prior art document relies on storing the location information on a server or on the separate devices, which requires communication between the devices. This furthermore limits this prior art solution to devices that are capable of communicating with each other.

### BRIEF SUMMARY OF THE INVENTION

The present invention seeks to provide a method that allows for the storage of a more accurate last reading position in an electronic document.

The present invention further seeks to provide a method that allows for a more accurate restoration of an electronic document on a computer.

The present invention further seeks to provide a computer program product comprising computer program code, when executed on a computer, causing the computer to implement at least one of the above methods of the present invention.

The present invention yet further seeks to provide a system including the above computer program product of the present invention.

In accordance with an aspect of the present invention, there is provided a method of approximating a final reading position in an electronic document, comprising determining a reading speed of a user reading the electronic document; approximating said final reading position on the most recently accessed page of the electronic document using the determined reading speed; and digitally storing the approximated final reading position for retrieval by a computer adapted to display the electronic document.

By determining the reading speed, e.g. a number of text units per time unit, e.g. words, lines, paragraphs or pages, per time unit, the final reading position on the last page accessed by the user can be accurately approximated, for instance by multiplying the display time of the most recently accessed page by said reading speed or by approximating said final reading position from an initial reading position of the electronic document based on the determined reading speed and the elapsed display time. The approximated final reading position may for instance be stored in the electronic document or in a separate user file.

In an embodiment, said digitally storing step comprises storing the approximated final reading position on an electronic repository that can be accessed by said computer over a network. Such an electronic repository may for instance be an Internet-accessible server and/or a server accessible over a mobile phone network, e.g. a UMTS, 2G, 3G, 4G or 5G network, in which case the approximated final reading position may for instance be stored in a user file on the server. The electronic repository may for instance comprise a server on which the application for displaying the electronic document can be accessed.

In an embodiment, the approximating step is triggered by a signal indicating that the user has interrupted reading the electronic document. This ensures that the approximating step is only executed when necessary, thus improving the efficiency of the method. On battery-powered devices, such an improved efficiency translates to a prolonged battery lifetime. Such a signal may for instance be generated when the user engages a control such as the power button or a ‘close document menu option’ of the electronic device.

Alternatively or additionally, said signal is generated by a sensor of an electronic device on which the document is displayed, such as a motion sensor, which has the advantage that the final reading position is approximated even without the user actively terminating the application displaying the electronic document.

The method may further comprise interrupting the determining of said reading speed in response to said signal and resuming the determining of said reading speed in response to a further signal indicating that the user has resumed reading the electronic document. This is particularly advantageous if the signal is sensor-generated as it ensures that the statistics from which the reading speed is derived are only collected by the method when the user is actively reading the electronic document, thus improving the accuracy and efficiency of the method.

In an embodiment, the step of determining a reading speed of a reader of the electronic document comprises determining a text unit processing rate, wherein determining a text unit processing rate comprises the steps of determining a first reading time it takes the user to read a number of text units and determining the text unit processing rate by dividing said number of text units by said amount of time, wherein a text unit is selected from the group comprising a word, a line, a paragraph and a page.

The text unit processing rate of the user is a suitable metric to accurately approximate the final reading position of the user. For instance, when the approximating step comprises multiplying the display time of the most recently accessed page by a page reading speed, the size of the fraction of the page read by the user is accurately approximated, such that a pointer may be inserted into the electronic document that points towards the end point of this fraction.

Advantageously, the step of determining the amount of time it takes the user to read a number of text units comprises determining a second reading time it takes to read a particular number of text units and discarding said second reading time and said page from determining said text unit processing speed of if the further amount of time exceeds a defined threshold.

In case the electronic document contains different types of content, the step of determining the reading speed may comprise determining the reading speed of each of said types of content for said user. This for instance may be used to more accurately approximate the final reading position on the most recently accessed page of the electronic document by determining the type of content on the most recently accessed page and approximating the final reading position using the reading speed of the user for that content.

In a further embodiment, in case the most recently accessed page of the electronic document comprises at least two of said types of content, the step of approximating the reading position may comprise determining a weighted reading speed based on the respective reading speeds for said at least two types of content. This may further improve the accuracy of the approximation of the final reading position.

In yet another embodiment, the method further comprises periodically repeating the step of determining a reading speed to capture changes in said reading speed. This has the advantage that the actual reading speed is closely monitored, as the reading speed of the user may vary during a single reading session, e.g. through fatigue or a loss of concentration or interest in the content of the electronic document. This may therefore further improve the accuracy of the approximation of the final reading position.

In accordance with another aspect of the present invention, there is provided a method of displaying an electronic document having an approximated final reading position associated therewith in accordance with an embodiment of the above method of the present invention, comprising displaying the page of the electronic document comprising the approximated final reading position such that the approximated final reading position is positioned in a defined region of a display screen of said computer. This has the advantage that the chance of the actual final reading position being displayed on the display screen is maximized.

In accordance with yet another aspect of the present invention, there is provided a computer program product comprising a computer-readable storage medium having computer-readable program code, when executed on a computer, causing the computer to implement the steps of an embodiment of any of the methods of the present invention.

In accordance with a further embodiment of the present invention, there is provided a system comprising a processor and the computer program product of the present invention, wherein the processor is adapted to execute said program code. This system can enable the more accurate approximation of the final reading position of an electronic document read on the system as explained in more detail for the various embodiments of the corresponding method, or in case of the system being the destination system to which the electronic document is transferred, provides a system that is more likely to display an initial reading page of the electronic document that contains the final reading position in the electronic document on the previous electronic device.

### BRIEF DESCRIPTION OF THE DRAWINGS

Preferred embodiments of the present invention will now be described, by way of example only, with reference to the following drawings, in which:

FIG. 1 schematically depicts a problem addressed by at least some embodiments of the present invention;

FIG. 2 schematically depicts a flow chart of a method according to an embodiment of the present invention;

FIG. 3 schematically depicts a flow chart of an aspect of a method according to another embodiment of the present invention;

FIG. 4 schematically depicts a flow chart of an aspect of a method according to yet another embodiment of the present invention;

FIG. 5 schematically depicts a flow chart of an aspect of another method according to yet another embodiment of the present invention; and

FIG. 6 schematically depicts a system according to an embodiment of the present invention.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

The various embodiments of the method of the present invention may be stored on a computer program product comprising a computer-readable storage medium. The computer-readable storage medium may be any medium that can be accessed by a computer for the retrieval of digital data from said medium. Non-limiting examples of a computer-readable storage medium include a CD, DVD, flash memory card, a USB memory stick, a random access memory, a read-only memory, a computer hard disk, a storage area network, a network server, an Internet server and so on.

In the context of the present application, an electronic document can be any computer-readable file that comprises text, which may be embedded in an image, e.g. a cartoon, and that when opened in a computer program or application on a computer is displayed to a user such that the text can be read by the user. In particular, the electronic document preferably is an e-book, although the electronic document may also be a newspaper, a work of reference such as an encyclopedia, a user manual, a body of text generated by a user in a word processing application, a web page and so on. The electronic document may be in any suitable file format. In the context of the present application, a computer is an electronic device comprising a processor capable of running an application for displaying an electronic document. More specifically, computer may be an electronic book (e-book) reader, a smart phone, a tablet, a personal digital assistant, a laptop computer, a desktop computer, a (web) server and so on.

In the context of the present application, a user reading speed is the time it takes a user to read a unit of text. Any suitable granularity may be used for defining what constitutes a unit of text. For instance, the reading speed may be expressed in terms of number of pages per minute, number of paragraphs per minute, number of lines per minute, number of words per minute and so on. Alternatively, the reading speed may be expressed as the time it takes to read a unit portion of text; for instance, the number of seconds it takes a user to read a line, paragraph or page. Any suitable time unit may be used to express time in the reading speed.

In the context of the present application, an electronic repository is a digital storage medium that can be accessed by a computer for retrieving the digitally stored content. The electronic repository may be a memory, a hard disk, a collection of hard disks, a storage area network and so on, which may be accessible via a network such as a wired or wireless local area network, the Internet, a mobile communication network such as UMTS, 2G, 3G, 4G, 5G and so on. The electronic repository may comprise an account of the user for managing, e.g. synchronizing, the various computers used for accessing the electronic document, in which case the approximated final reading position of the electronic document may be stored in the user account.

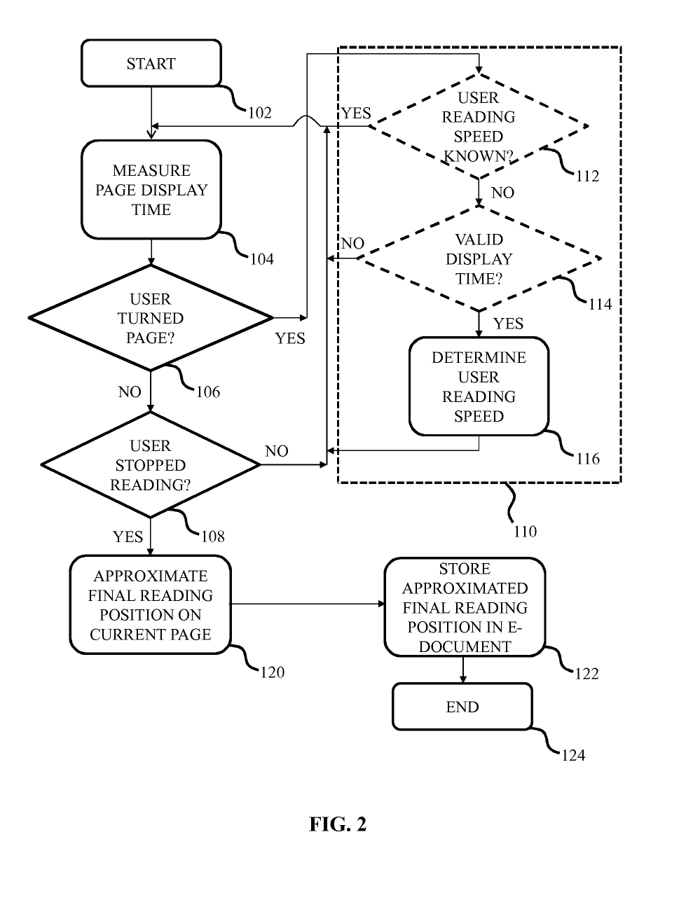

FIG. 2 depicts an example embodiment of a method of approximating a final reading position in an electronic document. The method starts in step 102, which typically comprises a user opening an electronic document on a computer. The computer may be configured to retrieve the last reading position of the electronic document from an electronic repository that contains relevant user information including the last reading position, or alternatively from the electronic document itself, and use this last reading position to determine which part of the electronic document is to be displayed to the user as the initial page of the reading session.

Once the initial page is displayed, the method proceeds to step 104 in which the duration of the time the initial page is displayed is timed. This may be implemented in any suitable manner, e.g. by using the system clock of the computer to obtain the timing information.

The timing of the page can be interrupted by two events. The first of those events is shown in step 106, which is when the user instructs the computer to jump to the next page. This may be achieved by any suitable command. For instance, the user may press an appropriate button on the computer, may touch the screen in a predefined manner to invoke this command, may briefly shake or tilt the computer such that a motion sensor of the computer can detect the movement and interpret it as a page turning command and so on.

Upon detecting the page jump instruction, the method proceeds to a sub-routine 110 in which the reading speed of the user is determined. The sub-routine 110 may comprise an optional step 112 in which it is checked if the user reading speed has already been determined, or if there is sufficient confidence in the accuracy of the determined reading speed, e.g. because a sufficient number of data points, (for instance a sufficient number of pages) has been included in the determination of the reading speed. If this is the case then the method reverts back to step 104 where the display time of the next displayed page is measured.

In an embodiment, the user reading speed may be periodically updated by the sub-routine 110. For instance, it may be assumed that if the user reading speed has been based on a defined minimum number of text units (words, lines, paragraphs, pages and so on), there is a sufficient confidence in the accuracy of the determined user reading speed such that for subsequently displayed pages it is not necessary to update the user reading speed, as explained above. However, the user reading speed may change over time, for instance because of loss of concentration, interest or because of fatigue, such confidence may reduce over time. In such a case, it may be further checked in step 112 (or in a separate optional step not shown in FIG. 2) how long ago the user reading speed was determined, and in case this amount of time exceeds a defined threshold, it may be decided to recalculate the user reading speed to capture such changes in reading speed.

The sub-routine 110 may further comprise an optional step 114 in which it is checked if the measured display time of the displayed page falls within an acceptable range. For instance, if the display time exceeds a defined upper threshold, this may indicate that the reader may have stopped reading the page for at least a part of the time the page was displayed. Similarly, if the display time falls below a defined lower threshold, this may be an indication that the user has skipped at least part of the page. As including such statistics in the reading speed evaluation may compromise the accuracy of the evaluation, it may therefore be decided that in such a case the page statistics are not included in the determination of the reading speed of the user, in which case the method may return to step 104 where the display time of the next displayed page is measured.

The aforementioned thresholds applied in optional step 114 may be static thresholds, i.e., thresholds that are not updated, or dynamic thresholds, i.e. thresholds that are updated based on changes in the determined reading speed.

In an embodiment, each threshold may be set as a percentage or fraction of the time it would take a user to read that page based on the up-to-date value of the determined user reading speed. For instance, for a page containing 300 words and a user reading at a speed of 5 words per second, the typical time it would take the user to read the page would be 300/5=60 seconds. The range of acceptable display times may for instance be defined from 50-200% of this typical time, i.e. 30-120 seconds. If the page display time falls outside this range, the page statistics, e.g. word count and page display time, are not considered in the determination of the user reading speed. It should be appreciated that the values in the above example are entirely non-limiting and that any suitable threshold or range end point of the range may be chosen.

In the absence of at least one of optional steps 112, 114 or upon determination in these steps that the user reading speed should be determined, the method proceeds to step 116 in which the user reading speed is determined. This may be done in any suitable way.

In an embodiment, the page statistics such as display time and optionally text properties such as the number of words, lines and/or paragraphs and so on may be stored in a memory of the computer implementing the method of the present invention, and may be accumulated in step 116 to obtain an average page reading speed for the user, e.g. by dividing the total number text units, such as words, lines, paragraphs or pages and so on read by the sum of the page display times to obtain this average. As it will be immediately apparent to the skilled person how this may be implemented on a computer, this will not be explained in further detail for the sake of brevity only.

Alternatively, the reading speed may be expressed as the time it takes a user to read a unit portion of text, e.g. a defined number of words, lines, paragraphs, pages and so on.

At this stage, it is noted that although the measuring of the page display time in step 104 is shown to commence upon completion of the sub-routine 110, this is shown for the sake of clarity only. It is equally feasible and in at least some embodiments preferable that the page display time measurement of step 104 runs in parallel with sub-routine 110 to ensure that the measurement of the page display time is as accurate as possible.

The above process flow is repeated until there is an indication that the user has stopped reading, as shown in step 108. Such an indication may for instance be a signal generated in response to the user giving an explicit command to the computer on which the electronic document is displayed, e.g. by the user may press an appropriate button on the computer, may touch the screen in a predefined manner to invoke this command, or the computer may comprise a sensor that detects that the user has stopped reading.

For instance, the computer may comprise a motion sensor and/or an orientation sensor that detects that the user has placed the computer in a substantially horizontal orientation, thus indicating that the computer has been put down.

Alternatively, the computer may comprise a light sensor that detects that the user has covered the display screen of the computer, thus again suggesting that the user has stopped reading. Other embodiments of suitable sensors will be apparent to the skilled person.

Upon the detection of the signal indicating that the user has stopped reading the electronic document, the method will proceed to step 120 in which the final reading position of the user is approximated. In a preferred embodiment, this is achieved by extrapolating the final reading position from the display time of the most recently displayed page and the determined user reading speed. For example, for a most recently displayed page having been displayed for 30 seconds for a user having an average reading speed of 40 seconds per page (or 1.5 pages per minute), the final reading position will lie at 30/40=¾ down the page.

At this point it should be appreciated that the appropriate formula for approximating the final reading position will depend of the format in which the reading speed of the user is expressed.

For instance, in case of a user reading speed R being expressed as text units/time unit (e.g. words/sec, words/min, page/sec, page/min and so on), the appropriate formula may be A=D×R in which A is the approximate final reading position expressed in text units and D is the display time of the most recently displayed page. For example, for a most recently displayed page containing 300 words having been displayed for 30 seconds and a user reading speed of 3 words per second, the approximate final reading position will be 3*30=the 90^{th} word on the page

Alternatively, if the reading speed R′ of a user is expressed in time per text unit, the appropriate formula may be A=D/R′. For example, for a most recently displayed page containing 300 words having been displayed for 30 seconds and a user reading speed of ⅓ of a second per word, the approximate final reading position will be 30 divided by ⅓=the 90^{th} word on the page.

Many possible variations will be immediately apparent to the skilled person. For instance, as it is unlikely that a user will stop reading mid-sentence, step 120 may further comprise finding the nearest full stop to the approximated final reading position and adjusting the approximated final reading position to the nearest full stop to improve the accuracy of the approximation. As another example, the measured display time of the most recently displayed page may be reduced by a fixed amount to factor in the likely delay between the user stopping reading and the user signaling the computer accordingly.

After the final reading position has been determined in step 120, the method proceeds to step 122 in which the approximated final reading position is stored on an electronic repository, e.g. in a user file or by tagging the electronic document with the approximated final reading position prior to saving the electronic document such that it upon reopening the document a page including this approximated final reading position can be displayed. The approximated final reading position may be stored in any suitable format and any suitable file, e.g. a user profile, a user file and so on. When stored in the electronic document, this may be done in any suitable manner, e.g. by storing the approximated final reading position in metadata of the electronic document.

After the electronic document has been updated in step 122, the method ends in step 124, e.g. by saving the electronic document and closing the application used for displaying the application and/or shutting down the computer.

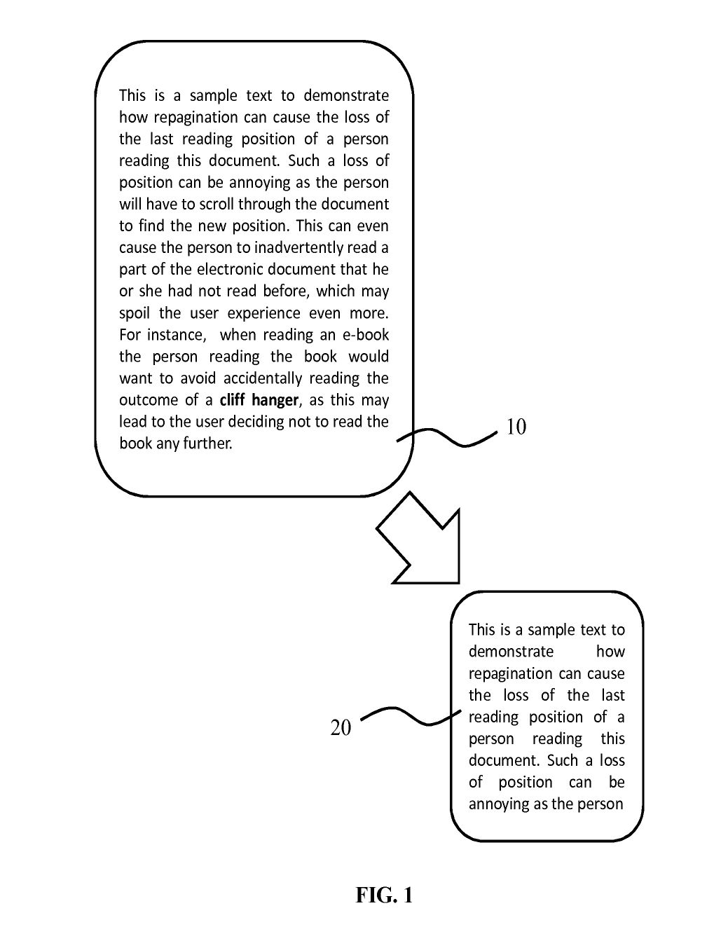

In an embodiment, the determined user reading speed may also be saved at this (or any other suitable) stage of the method shown in FIG. 1. For instance, the determined speed may be stored in a user file on an electronic repository, e.g. locally on the computer, which may be accessed the next time the application for displaying the electronic document is launched at the start 102. This has the advantage that it is not necessary to first evaluate the time it takes the user to read a number of pages before being able to get an accurate approximation of the reading speed of the user.

Alternatively, the user reading speed may also be stored in the electronic document, e.g. in step 122. This is particularly advantageous if the speed is expressed in terms of number of words read per time unit, as this speed is (largely) independent of the screen size of the computer on which the electronic document is displayed, whereas changes in screen size will typically affect the length of a line or the amount of content, e.g. text, on a page, such that a reading speed expressed in those terms is not screen size-independent.

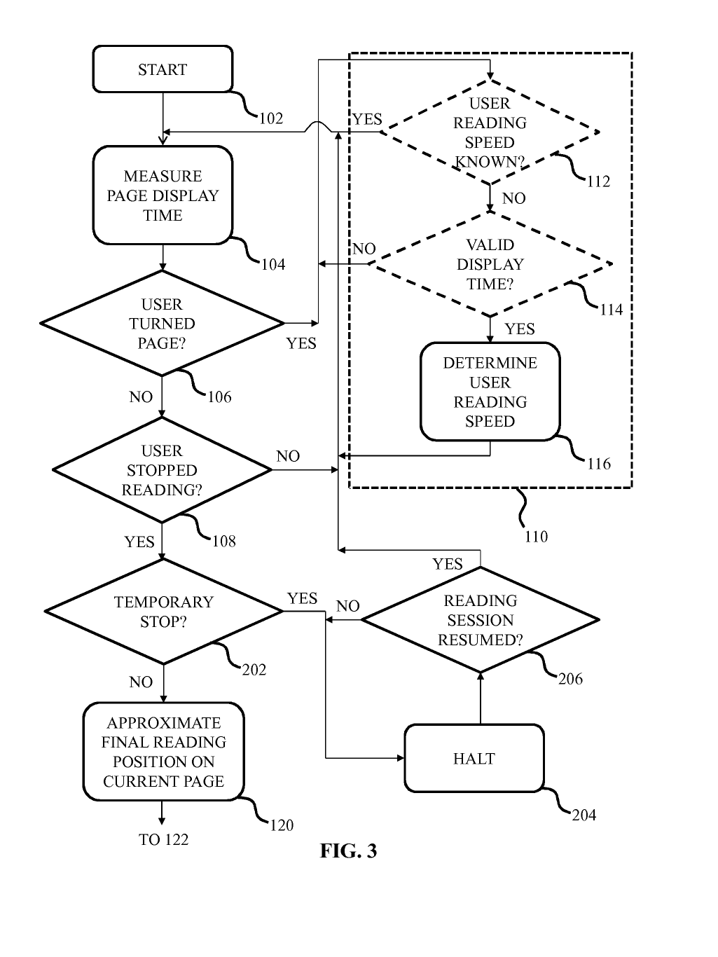

In an embodiment, the method may be configured to distinguish between a user interrupting a reading session and terminating a reading session. This is shown in FIG. 3. An interruption of a reading session may for instance be detected by a sensor of the computer, e.g. by noticing that the user has closed the cover of the computer or put down the computer, as previously explained. To this end, the method may comprise an additional step 202 in which it is determined whether or not the termination of the reading session is temporary in the sense that the user is not expected to close down the application but is instead expected to resume the same reading session, which for instance may be detected by the generation of such a sensor signal.

If it is decided that the user has temporarily interrupted his reading session, the method may move to the halt stage 204, which for instance may invoke a sleep mode of the computer. In the halt state 204, the method checks as shown in step 206 if the reader has resumed reading, which for instance may be detected by the generation of a further signal of the aforementioned sensors, which may signal the removal of the cover or opening of the computer or the computer being in motion, thus indicating that the user has picked up the computer to resume the reading session. If such a further signal is detected, the method resumes monitoring the display time of the current page in step 104. This has the advantage that the acquisition of the reading statistics is interrupted during such a temporary interruption of a reading session, thus further improving the accuracy of the reading speed derived from these statistics and furthermore providing a more power-efficient implementation.

On the other hand, if in step 202 it is concluded that the reading session of the user has ended, e.g. by the user closing down the application or switching off the computer, the method will proceed to step 120 and its subsequent steps as explained in the detailed description of FIG. 2.

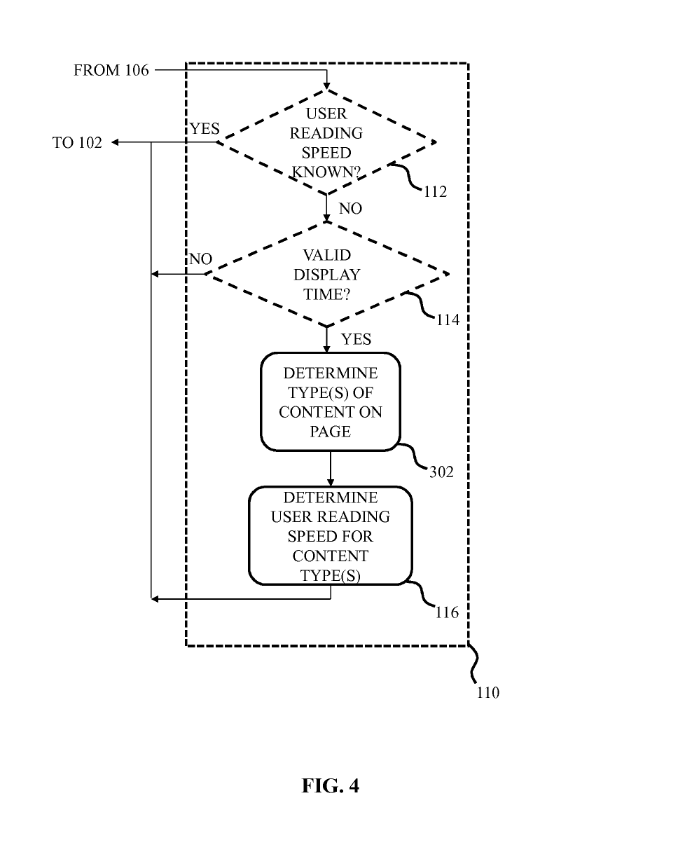

In a further embodiment of the present invention, the method of approximating a final reading position in an electronic document may determine separate reading speeds for different types of content. An aspect of this method is shown in FIG. 4. In this embodiment, the sub-routine 110 is extended with an additional step 302 in which the one or more types of content on the displayed page are determined, after which the sub-routine proceeds to step 116 to determine the reading speed for those types of content. For instance, the method may evaluate the information density (e.g. number of words) on a page and decide based on this density if the content is likely to be of a particular type. For instance, dialogue in a fictional work is generally less dense than description in the same work, which can lead to different reading speeds for these different types of content.

Alternatively, the reader may for instance detect pages with and without images, as pages with images will typically be read at a different speed than pages without images, or the reader may for instance detect pages with or without mathematical formulas as the presence of such a formula may for instance be considered likely to contain scientific evidence, which again will be read at a different speed by a user than e.g. a page containing images, dialogue or combinations of different types of content.

Consequently, when determining the approximate final reading position in step 120 as previously explained, the method will evaluate the type of content on the most recently displayed page and select the appropriate reading speed for that type of content when approximating the final reading position. In case the most recently displayed page contains more than one type of content, the method may construct a blended or weighted reading speed using the reading speeds of the types of content detected on the most recently displayed page. For instance, for a page containing 70% dialogue and 30% description, a blended reading speed comprising of 0.7 times the reading speed for dialogue and 0.3 times the reading speed for description may be used as a first approximation.

This algorithm may be refined by considering the location of the content on the most recently displayed page. For instance, if the top of the page contains content of a first type, e.g. dialogue, and the remainder of the page contains content of a second type, e.g. description, the method may first approximate the final reading position using only the reading speed for the first content type, and only if the final reading position is approximated to lie within the content of the second type is the approximation repeated for using a blended reading speed. This may be further refined if it can be determined how long it would have taken the user to read the whole of the first content, which amount of time may be deducted from the total display time of the most recently displayed page to yield a reduced total display time used to approximate the final reading position starting from the end of the first type of content on the most recently displayed page. Further refinements or alternatives will be apparent to the skilled person.

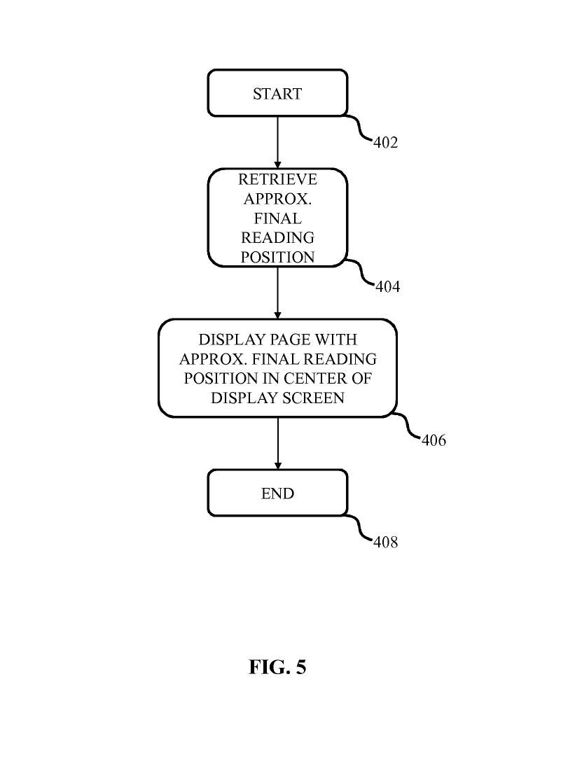

Upon reopening the electronic document on the same or a different computer, the application for displaying the electronic document will retrieve the approximated final reading position from the electronic repository, e.g. by accessing the appropriate user file or from the electronic document. An example embodiment of such a method is shown in FIG. 5. In step 402, the application for displaying the electronic document is launched on a computer, which may include retrieving the electronic document from an electronic repository, e.g. a computer-readable medium such as a memory or hard disk.

In step 404, the approximated final reading position is extracted from the location where it is stored, e.g. from a user file on the electronic repository or from the electronic document, which is used in step 406 to display a portion (e.g., a page) of the electronic document including the approximated final reading position. The approximated final reading position is typically displayed in a defined region of the display screen. Preferably, the defined region is the mid-center of the display screen as this maximizes the amount of text before and after the approximated final reading position that is in this initial view of the electronic document, thus minimizing the chance that the actual final reading position of the user in the previous reading session falls outside the initially displayed text of the electronic document in this new reading session. It should however be understood that it is equally feasible to place the approximated final reading position at a different defined region of the display screen, e.g. the top or the bottom of this screen.

After the electronic document has been opened and displayed in this manner, the method terminates in step 408.

At this stage, it is noted that the use of the approximated final reading position to restore an electronic document to a previous view may be combined with approaches that are already known, such as storing information of the most recently accessed page in the electronic document. The latter information is of course equally useful if the electronic document is restored on the same computer, such that no reformatting such as repagination occurs that can lead to the loss of the actual final reading position in the initial display of the reopened electronic document. Therefore, embodiments of the method shown in FIG. 5 may be extended with a checking step in which it is checked if the electronic document needs reformatting, which is indicative of the document being reopened on a computer with a different screen size, and only use the approximated final reading position if such reformatting indeed occurs.

Embodiments of the method of the present invention may be made available as a computer program product comprising a computer-readable storage medium, wherein the various steps of the method are stored on the computer-readable storage medium in the form of computer-readable program code that when executed on a suitably adapted computer, will cause the computer to execute the steps of such a method.

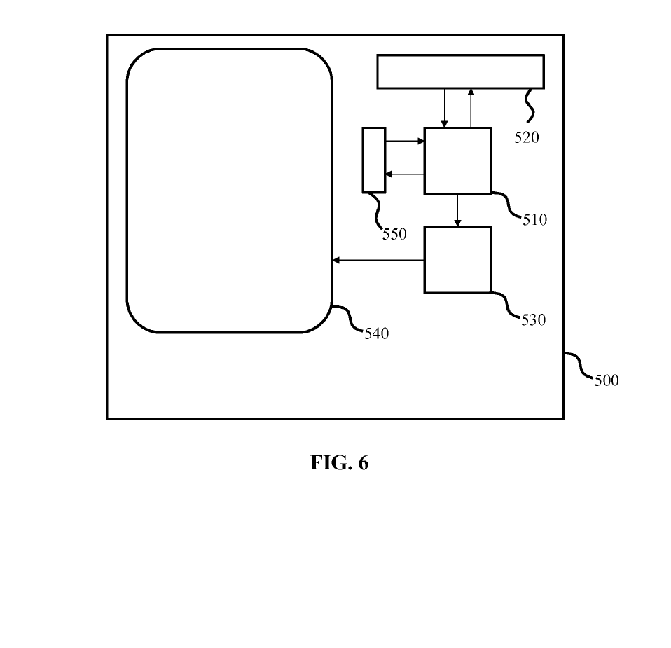

FIG. 6 depicts an example system 500 in accordance with an embodiment of the present invention. The system 500, e.g. a computer, comprises a processor 510, a computer-readable storage medium 520 such as a hard disk and/or a memory, a graphics driver 530, a display screen 540 and an optional network interface 550. The system 500 is adapted to implement the embodiments of the methods of the present invention in the following manner.

An electronic document and the application for displaying the electronic document, which may include one or more of the embodiments of the method of the present invention, may be stored in the computer-readable storage medium 520.

Alternatively, the electronic document and/or the application for displaying the electronic document may be stored on a network-accessible electronic repository outside the system 500, in which case the processor 510 instructs the network interface 550 to access the electronic repository over the network and to retrieve the electronic document and/or the application for displaying the electronic document, which subsequently are stored in the computer-readable storage medium 520.

The processor 510 executes the application for displaying the electronic document, e.g. by instructing the graphics interface 530 to display the appropriate portion of the electronic document on the display screen 540.

In an embodiment, the processor 510 instructs the graphics interface 530 to display the appropriate portion of the electronic document on a defined region of the display screen 540, such as a mid-center position on the display screen 540.

The processor 510 determines the reading speed of the user reading the electronic document. At the same time, the processor 510 measures the display time of each page of the electronic document on the display screen 540.

The processor 510 subsequently approximates the final reading position of the user in response to a signal indicating that the user has stopped reading. This signal may be generated by a power button (not shown) on the system 500, a sensor (not shown) indicating that the system 500 is no longer in use or any other suitable source for such a signal.

The processor 510 subsequently instructs the storage of the approximated final reading position, e.g. by updating a metadata field in the electronic document or by updating the user file and storing the updated electronic document or user file in the computer-readable storage medium 520 or by instructing the network interface 550 to store the updated electronic document or user file on the network-accessible electronic repository.

Although the various elements of the system 500 are shown as discrete elements, it will be understood by the skilled person that at least some of the elements may be integrated into a single component. For instance, it is equally feasible that the graphics driver 530 forms part of the processor 510, and/or that at least part of the computer-readable storage medium 520 resides on the processor 510.

The computer-readable storage medium 520 comprises computer program code for implementing one or more embodiments of the methods shown in FIG. 2-5 by execution of this program code on the processor 510. In order to obtain the timing information required e.g. in step 104, the system 500 may further comprise a system clock (not shown), which for instance may reside on the processor 510 or on another part of the system. The system 500 may further comprise one or more sensors (not shown), such as a motion sensor, an orientation sensor, a light sensor and so on, for detecting the temporary interruption of a reading session of a user of the system 500 as previously explained.

In summary, disclosed is a (computer-implemented) method for approximating the final reading position in an electronic document such as an e-book. The final reading position is approximated by first establishing a reading speed of the reader of the e-book, which reading speed is used to approximate the final reading position on the most recently displayed page of the e-book, for instance by measuring how long the page has been displayed for and using the reading speed and this time period to obtain an approximate final reading position on the most recently displayed page. A computer program product containing this method and a system for executing this method are also disclosed.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method of approximating a final reading position in an electronic document, comprising:
determining (116) a reading speed of a user reading the electronic document;
approximating (120) said final reading position on the most recently accessed page of the electronic document using the determined reading speed; and
digitally storing (122) the approximated final reading position for retrieval by a computer adapted to display the electronic document.

2. The method of claim 1, wherein said digitally storing step comprises storing the approximated final reading position on an electronic repository that can be accessed by said computer over a network.

3. The method of claim 1, wherein the approximating step (122) is triggered by a signal indicating that the user has interrupted reading (202) the electronic document.

4. The method of claim 3, wherein said signal is generated by a sensor of the electronic device on which the electronic document is displayed.

5. The method of claim 3, further comprising:
interrupting (204) the determining of said reading speed in response to said signal; and
resuming the determining (116) of said reading speed in response to a further signal indicating that the user has resumed reading the electronic document.

6. The method of claim 1, wherein the step of determining a reading speed of a reader of the electronic document comprises determining a text unit processing rate, wherein determining a text unit processing rate comprises the steps of:
determining a first reading time it takes the user to read a number of text units; and
determining the text unit processing rate by dividing said number of pages by said amount of time, wherein said text unit is selected from the group comprising a word, a line, a paragraph and a page.

7. The method of claim 6, wherein the step of determining the first reading time it takes the user to read a number of text units comprises:
determining a second reading time it takes to read a particular page; and
discarding (114) said second reading time and said page from determining said page processing speed of if the further amount of time exceeds a defined threshold.

8. The method of claim 1, wherein the electronic document contains different types of content, wherein the step of determining the reading speed comprises determining (116) the reading speed of each of said types of content for said user.

9. The method of claim 8, wherein the most recently accessed page of the electronic document comprises at least two of said types of content, and wherein the step (120) of approximating the final reading position comprises determining a weighted reading speed based on the respective reading speeds of said at least two types of content.

10. The method of claim 1, wherein said approximating step (120) comprises approximating the final reading position from the reading speed and the display time of the most recently accessed page.

11. The method of claim 1, wherein said approximating step (120) comprises determining said final reading position from an initial reading position of the electronic document.

12. The method of claim 1, further comprising periodically repeating the step (116) of determining a reading speed to capture changes in said reading speed.

13. A method of displaying an electronic document comprising an approximated final reading position associated therewith in accordance with the method of claim 1, comprising:
displaying (406) the page of the electronic document comprising the approximated final reading position such that the approximated final reading position is positioned in a defined region of a display screen of said computer.

14. A computer program product comprising a computer-readable storage medium having computer-readable program code, when executed on a computer, causing the computer to implement the steps of the method of claim 1.

15. A system (500) comprising a processor (510) and the computer program product of claim 14, wherein the processor is adapted to execute said program code.
